(19) United States
(12) Patent Application Publication
(10) Pub. No.: US 2010/0163427 A1
(43) Pub. Date: Jul. 1, 2010

(54) METHODS AND SYSTEMS FOR ELECTROMACHINING OF A WORKPIECE

(76) Inventors: Yimin Zhan, Shanghai (CN); Renwei Yuan, Shanghai (CN); Yuangfeng Luo, Shanghai (CN)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/347,437

(22) Filed: Dec. 31, 2008

(51) Int. Cl. B23H 7/20; B23H 7/18; B23H 3/02; B23H 1/00

(52) U.S. Cl. 205/651; 204/230.2; 204/229.4; 219/69.11; 219/69.17

(57) ABSTRACT

An electromachining system is described. The electromachining system includes a computer numerical controller (CNC) device and an electromachining controller device coupled to the CNC device and a power supply. The electromachining system also includes an electromachining tool coupled to the CNC device and the power supply. The electromachining controller device is configured to control operation of the electromachining tool and the CNC device is configured to position the electromachining tool relative to a workpiece.

### BACKGROUND OF THE INVENTION

The field of the disclosure relates generally to control of an electromachining system, and more specifically to control of an electromachining system with a general computer numerical controller (CNC) device and an electromachining module.

Many metal components for commercial and industrial usage are machined. An amount of time spent machining a component is generally dependent on the material being machined and the machining method used. One machining method typically used for complex components, particularly those with contours, is milling. For complex applications, carbide cutters may be utilized. Another method of machining is electromachining. Examples of electromachining are electrical discharge machining (EDM) and electrochemical discharge machining (ECDM), which may be used for machining complex parts, as well as for machining dies and molds.

EDM is a process in which an electrically conductive metal workpiece is shaped by removing material through melting or vaporization by electrical sparks and arcs. The spark discharge and transient arc are produced by applying controlled pulsed direct current (DC) between the workpiece (typically anodic or positively charged) and the tool or electrode (typically the cathode or negatively charged). The end of the electrode and the workpiece are separated by a spark gap generally from about 0.01 millimeters to about 0.50 millimeters, and are immersed in or flooded by a dielectric fluid. The DC voltage enables a spark discharge charge or transient arc to pass between the tool and the workpiece. Each spark and/or arc produces enough heat to melt or vaporize a small quantity of the workpiece, thereby leaving a tiny pit or crater in the work surface. This is referred to as thermal erosion. The cutting pattern of the electrode is usually computer numerically controlled (CNC) whereby servomotors control the relative positions of the electrode and workpiece. The servomotors are controlled using relatively complex and often proprietary control algorithms to control the spark discharge and control gap between the tool and workpiece. By immersing the electrode and the workpiece in the dielectric fluid, a plasma channel can be established between the tool and workpiece to initiate the spark discharge. The dielectric fluid also keeps the machined area cooled and removes the machining debris. An EDM apparatus typically includes one or more electrodes for conducting electrical discharges between the electrode and the workpiece.

As stated above, along with EDM, another example of electromachining is ECDM. ECDM is a hybrid machining method where material is removed from a workpiece by both electrochemical dissolution of the material and thermal erosion (as described above with respect to EDM). ECDM may include a spark/arc discharge through an electrolytic medium. The electrolytic medium facilitates the electrochemical dissolution in addition to the thermal erosion caused by the spark/arc.

Typically, EDM and ECDM devices include a dedicated controller that controls both the EDM process and CNC motion of the workpiece and/or the machine tool. In order for a manufacturer to upgrade a milling system to an EDM and/or ECDM system, the manufacturer would have to purchase the dedicated controller.

### BRIEF DESCRIPTION OF THE INVENTION

In one aspect, an electromachining system is provided. The electromachining system includes a computer numerical controller (CNC) device and an electromachining controller device coupled to the CNC device and a power supply. The electromachining system also includes an electromachining tool coupled to the CNC device and the power supply. The electromachining controller device is configured to control operation of the electromachining tool and the CNC device is configured to position the electromachining tool relative to a workpiece.

In another aspect, an electromachining module is provided. The electromachining module includes a programmable automation controller and input/output interfaces coupled to the programmable automation controller and at least one of an electromachining tool, a power supply, and a computer numerical control (CNC) device. The input/output interfaces are configured to receive data signals from at least one of the CNC device and the electromachining tool and provide the data signals to the programmable automation controller. The input/output interfaces are also configured to receive instruction signals from the programmable automation controller and provide the instruction signals to at least one of the CNC device, the electromachining tool, and the power supply.

In yet another aspect, a method for electromachining of a workpiece is provided. The method includes coupling an electromachining module to a computer numerical controller (CNC) device, an electromachining tool, and a power supply. The method also includes coupling the CNC device and the power supply to the electromachining tool. The method also includes configuring the electromachining module to control operation of the electromachining tool and the power supply, and configuring the CNC device to position the electromachining tool relative to the workpiece.

### BRIEF DESCRIPTION OF THE DRAWINGS

FIG. 1 is a block diagram of an exemplary electromachining system that includes an exemplary electromachining module.

FIG. 2 is a block diagram of data flow within the exemplary electromachining system shown in FIG. 1.

FIG. 3 is a flowchart of an exemplary method for electromachining of a workpiece

### DETAILED DESCRIPTION OF THE INVENTION

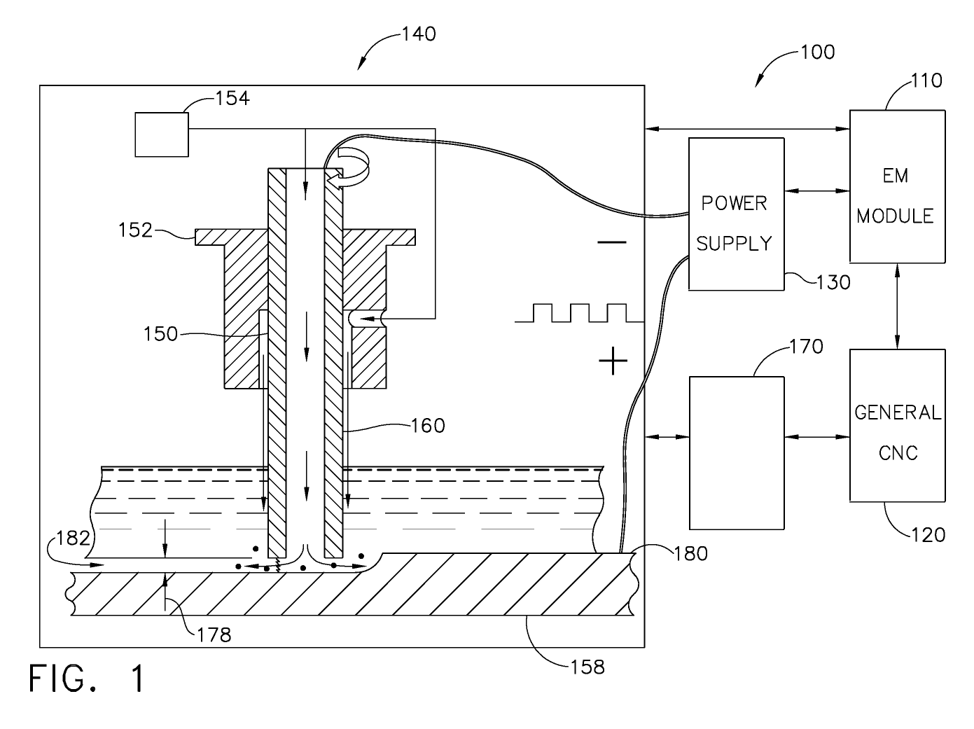

FIG. 1 is a block diagram of an exemplary electromachining system 100. In the exemplary embodiment, electromachining system 100 includes a n electromachining module 110, a general computer numerical controller (CNC) device 120, a power supply 130, and an electromachining tool 140. In the exemplary embodiment, electromachining tool 140 is at least one of an electrical discharge machining (EDM) tool and an electrochemical discharge machining (ECDM) tool. Electromachining tool 140 includes an electrode 150, a guide bushing 152, and a fluid source 154. Electrode 150 is positioned at least partially within guide bushing 152, and guide bushing 152 facilitates positioning of electrode 150 with respect to a workpiece 158. Electrode 150 may have any shape or size depending on the application. More specifically, electrode 150 is typically made of electrically conductive material such as graphite, and has a shape that generally mirrors a desired shape to be machined. In other embodiments, electrode 150 is formed from copper, tungsten copper, tellurium copper, tungsten carbide, brass, or tungsten. In the exemplary embodiment, electrode 150 has a hollow profile, which facilitates delivering a fluid from fluid source 154 to a workpiece 158. Although described as having a hollow profile, electrode 150 may also have a solid profile, with fluid being provided a long an external surface 160 of electrode 150.

In the exemplary embodiment, fluid source 154 is a pump t hat facilitates delivering fluid from fluid source 154 to workpiece 158. More specifically, fluid source 154 may supply a dielectric fluid from fluid source 154 to workpiece 158 for electromachining tool 140 to function as an EDM tool. The dielectric fluid insulates and cools electrode 150 and workpiece 158, conveys a spark between electrode 150 and workpiece 158, and flushes removed metal from workpiece 158. To function as an ECDM tool, fluid source 154 supplies an electrolyte medium to electrode 150 and workpiece 158 to facilitate the electrochemical dissolution.

In the exemplary embodiment, CNC device 120 is coupled to a motion device 170. Motion device 170 for example, may be a motorized arm configured to move electrode 150 with respect to workpiece 158, in accordance with instructions from CNC device 120. In the exemplary embodiment, CNC device 120 is a general CNC device. In other words, CNC device 120 is a CNC device configured for motion control in a traditional material cutting process. For example, CNC device 120 may be configured for use with a mechanical milling tool (not shown in FIG. 1). Furthermore, in the exemplary embodiment, CNC device 120 does not include, for example, a controller or processor that facilitates controlling an EDM tool or an ECDM tool.

In the exemplary embodiment, electromachining module 110 controls operation of electromachining tool 140. Controlling operation of electromachining tool 140 may include controlling fluid flow from fluid source 154, controlling a rotation of electrode 150 within guide bushing 152, controlling a height 178 of electrode 150 with respect to a surface 180 of workpiece 158, and/or controlling power supply 130. Controlling the height 178 of electrode 150 with respect to surface 180 facilitates maintaining a spark gap 182, also referred to herein as discharge gap 182, between electrode 150 and surface 180. In an exemplary embodiment, power supply 130 is a direct current (DC) power supply. In the exemplary embodiment, DC power supply 130 may provide a continuous voltage or a pulsed voltage across electrode 150 and workpiece 158. Workpiece 158 is not a part of electromachining system 100, but is operable with system 100.

In the exemplary embodiment, electromachining module 110 controls operation of power supply 130 and electromachining tool 140, and also sends motion instructions to CNC device 120. In other words, electromachining module 110 controls operation of electromachining tool 140 and CNC device 120 which facilitates shaping workpiece 158 via electromachining.

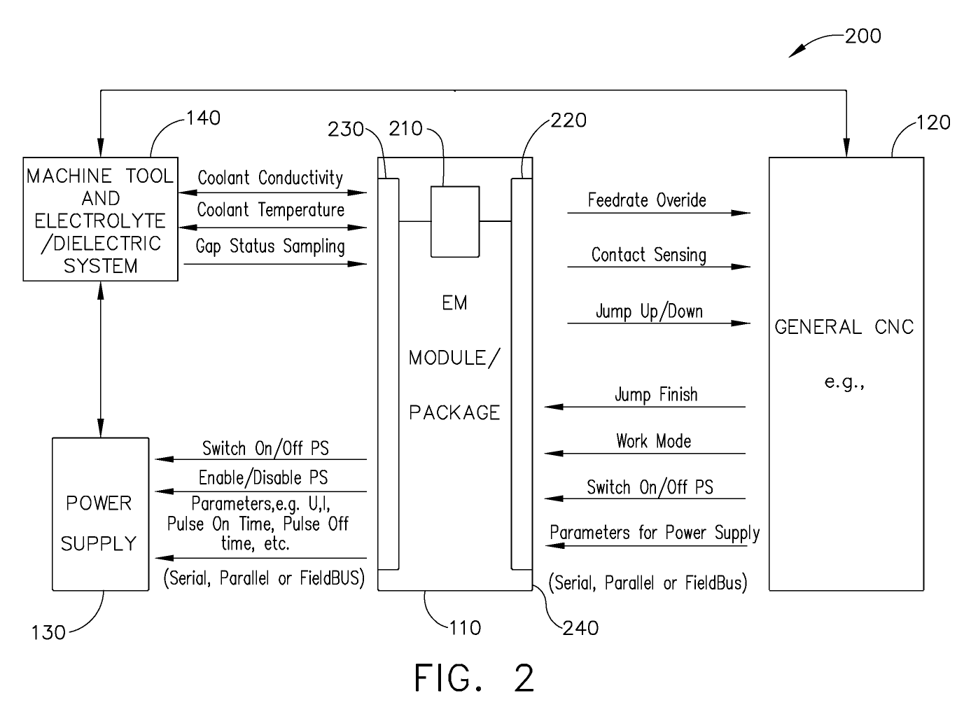

FIG. 2 is a block diagram 200 of data flow within electromachining system 100, shown in FIG. 1. More specifically, block diagram 200 illustrates data flow between electromachining module 110, CNC device 120, power supply 130, and electromachining tool 140. In the exemplary embodiment, electromachining module 110 includes a programmable automation controller 210 coupled to input/output (I/O) interfaces, for example I/O interfaces 220 and 230. In the exemplary embodiment, I/O interfaces 220 and 230 receive data signals from CNC device 120 and electromachining tool 140, and provide the data signals to programmable automation controller 210. For example, programmable automation controller 210 may receive data signals from electromachining tool 140 that include information on the status of discharge gap 182 (shown in FIG. 1) between electrode 150 (shown in FIG. 1) and workpiece 158 (shown in FIG. 1), and at least one of a coolant conductivity signal and a coolant temperature signal. In other examples, programmable automation controller 210 may receive data signals from CNC device 120 that include information on at least one of a jump finish data signal, a work mode data signal, and an operating parameter for the power supply data signal.

In the exemplary embodiment, I/O interfaces 220 and 230 also receive instruction signals from programmable automation controller 210 and provide the instruction signals to CNC device 120, electromachining tool 140, and power supply 130. For example, programmable automation controller 210 may send instruction signals to electromachining tool 140 that include instructions on a coolant conductivity and/or a coolant temperature. Programmable automation controller 210 may also send instruction signals to power supply 130 including, for example, a power supply on/off instruction, a power supply enable/disable instruction, a power supply peak voltage setting instruction, a power supply peak current setting instruction, and a power supply pulse on/off time instruction. Furthermore, programmable automation controller 210 may also send instruction signals to CNC device 120 including, for example, a feedrate override instruction signal, a contact sensing instruction signal, and a jump up/down instruction signal. In the exemplary embodiment, electromachining module 110 may also include a housing 240 that at least partially encloses programmable automation controller 210 and I/O interfaces 220 and 230. Packaging programmable automation controller 210 and I/O interfaces 220 and 230 within housing 240 facilitates providing a manufacturer with a standalone electromachining controller that may be added to a general CNC device to convert, for example, a mechanical milling system to an electromachining system.

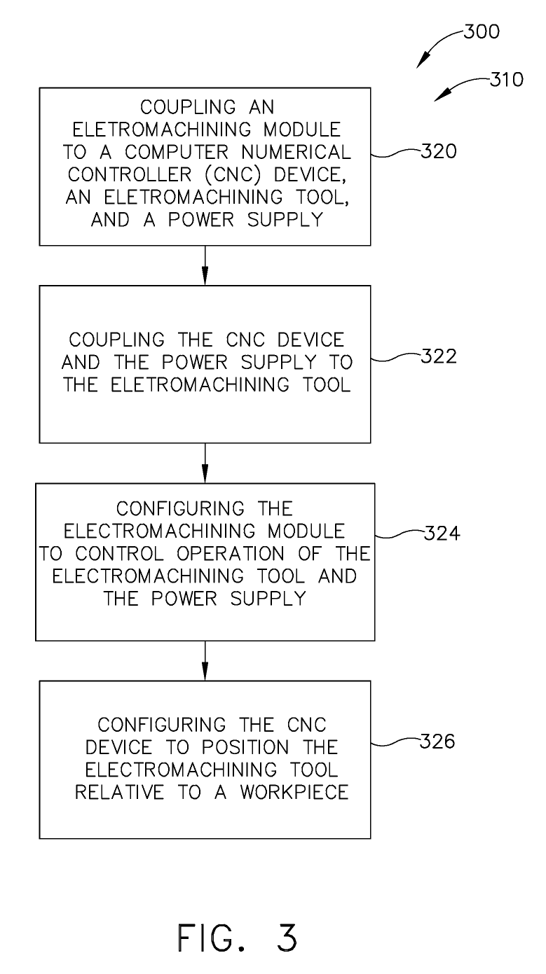

FIG. 3 is a flowchart 300 of an exemplary method 310 for electromachining of a workpiece. Method 310 includes coupling 320 an electromachining module to a computer numerical controller (CNC) device, an electromachining tool, and a power supply. For example, method 310 includes coupling 320 electromachining module 110 (shown in FIG. 1) to CNC device 120 (shown in FIG. 1), to electromachining tool 140 (shown in FIG. 1), and to power supply 130 (shown in FIG. 1). As described above, CNC device 120 comprises a general CNC device configured to be used in, for example, mechanical milling, or any other non-electrical discharge based process. Method 310 also includes coupling 322 CNC device 120 (shown in FIG. 1) and power supply 130 (shown in FIG. 1) to electromachining tool 140 (shown in FIG. 1).

In the exemplary embodiment, method 310 also includes configuring 324 an electromachining module to control operation of an electromachining tool and a power supply. For example, method 310 may include configuring 324 electromachining module 110 (shown in FIG. 1) to control operation of electromachining tool 140 (shown in FIG. 1) and power supply 130 (shown in FIG. 1). In some embodiments, configuring 324 electromachining module 110 to control operation of electromachining tool 140 and power supply 130 includes configuring electromachining module 110 to receive data signals from CNC device 120 and electromachining tool 140 and to provide instruction signals based at least partially on the received data signals. Configuring electromachining module 110 to receive data signals from CNC device 120 may include configuring electromachining module 110 to receive at least one of a jump finish data signal, a work mode data signal, and an operating parameter for the power supply data signal.

In the exemplary embodiment, configuring 324 electromachining module 110 to control operation of electromachining tool 140 and power supply 130 also includes configuring electromachining module 110 to provide instruction signals to at least one of electromachining tool 140, CNC device 12 0, and power supply 130. More specifically, configuring electromachining module 110 to provide instruction signals to electromachining tool 140 includes configuring electromachining module 110 to provide at least one of a coolant conductivity instruction and a coolant temperature instruction to electromachining tool 140. Configuring electromachining module 110 to provide instruction signals to power supply 130 includes configuring the electromachining module to provide at least one of a power supply on/off instruction, a power supply enable/disable instruction, a power supply peak voltage setting instruction, a power supply peak current setting instruction, and a power supply pulse on/off time instruction to the power supply. Furthermore, configuring electromachining module 110 to provide instruction signals to CNC device 120 includes configuring electromachining module 110 to provide at least one of a feedrate override instruction signal, a contact sensing instruction signal, and a jump up/down instruction signal to CNC device 120.

In the exemplary embodiment, method 310 also includes configuring 326 CNC device 120 (shown in FIG. 1) to position electromachining tool 140 (shown in FIG. 1) relative to a workpiece, for example, workpiece 158 (shown in FIG. 1). Based on instructions from electromachining module 110, CNC device 120 positions electromachining tool 140 relative to workpiece 158 to facilitate electromachining of workpiece 158.

The electromachining system and method described above includes a general CNC device, an electromachining module, and an electromachining tool. More specifically, the electromachining module is described above for use with a general CNC device and an EDM tool and/or ECDM tool. The system and method described herein are not limited to use with an EDM tool or an ECDM tool, but rather, the electromachining module may be included within any type of machining system. For example, in some embodiments, the electromachining module described above is configured to retrofit a CNC device that does not include electromachining capabilities.

The above-described electromachining module, and system and method for using the electromachining module, are reliable and cost-effective. Adding electromachining capabilities to a general CNC device, rather than purchasing a combined electromachining process controller/CNC device, may provide substantial cost savings to a manufacturer. As a result, the electromachining module described herein is part of a cost-effective and reliable electromachining system.

Exemplary embodiments of systems and methods for electromachining are described above in detail. The systems and methods are not limited to the specific embodiments described herein, but rather, components of the systems and/or steps of the methods may be utilized independently and separately from other components and/or steps described herein. For example, the systems and methods are not limited to practice with only the electromachining described herein. Rather, the exemplary embodiment can be implemented and utilized in connection with many other machining processes.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electromachining system comprising:
a computer numerical controller (CNC) device;
an electromachining controller device coupled to said CNC device and a power supply; and
an electromachining tool coupled to said CNC device and said power supply, said electromachining controller device configured to control operation of said electromachining tool and said CNC device configured to position said electromachining tool relative to a workpiece.

2. An electromachining system in accordance with claim 1, wherein said electromachining tool comprises at least one of an electrical discharge machining (EDM) tool and an electrochemical discharge machining (ECDM) tool.

3. An electromachining system in accordance with claim 1, wherein said electromachining tool comprises an electrode spindle system and a dielectric system, said electrode spindle system configured to receive a first and a second electrode.

4. An electromachining system in accordance with claim 1, wherein said CNC device comprises a general CNC device configured to control motion in a traditional material cutting process.

5. An electromachining system in accordance with claim 4, wherein traditional metal cutting processes comprise at least one of milling and lathe machining.

6. An electromachining system in accordance with claim 4, wherein said electromachining controller device facilitates controlling an EDM/ECDM process using said general CNC device.

7. An electromachining system in accordance with claim 1, wherein said power supply comprises a direct current (DC) power source.

8. An electromachining module comprising:
a programmable automation controller; and
input/output interfaces coupled to said programmable automation controller and at least one of an electromachining tool, a power supply, and a computer numerical control (CNC) device, said input/output interfaces configured to:
receive data signals from at least one of said CNC device and said electromachining tool and provide the data signals to said programmable automation controller; and
receive instruction signals from said programmable automation controller and provide the instruction signals to at least one of said CNC device, said electromachining tool, and said power supply.

9. An electromachining module in accordance with claim 8, wherein said electromachining tool comprises at least one of an electrical discharge machining (EDM) tool and an electrochemical discharge machining (ECDM) tool.

10. An electromachining module in accordance with claim 8, wherein said CNC device comprises a general CNC device configured to control motion in a traditional material cutting process, wherein said traditional material cutting process comprises at least one of drilling and milling.

11. An electromachining module in accordance with claim 8, further comprising a housing configured to at least partially enclose said programmable automation controller and said input/output interfaces.

12. A method for electromachining of a workpiece, said method comprising:
coupling an electromachining module to a computer numerical controller (CNC) device, an electromachining tool, and a power supply;
coupling the CNC device and the power supply to the electromachining tool;
configuring the electromachining module to control operation of the electromachining tool and the power supply; and
configuring the CNC device to position the electromachining tool relative to the workpiece.

13. A method in accordance with claim 12, wherein the CNC device comprises a general CNC device, wherein the general CNC device is configured to be used in mechanical milling.

14. A method in accordance with claim 12, wherein configuring the electromachining module to control operation of the electromachining tool and the power supply comprises configuring the electromachining module to receive data signals from the CNC device and the electromachining tool and to provide instruction signals based at least partially on the received data signals.

15. A method in accordance with claim 14, wherein configuring the electromachining module to receive data signals from the electromachining tool comprises configuring the electromachining module to receive at least one of a gap status data signal, a coolant conductivity signal, and a coolant temperature signal from the electromachining tool.

16. A method in accordance with claim 14, wherein configuring the electromachining module to receive data signals from the CNC device comprises configuring the electromachining module to receive at least one of a jump finish data signal, a work mode data signal, and an operating parameter for the power supply data signal.

17. A method in accordance with claim 12, wherein configuring the electromachining module to control operation of the electromachining tool and the power supply comprises configuring the electromachining module to provide instruction signals to at least one of the electromachining tool, the CNC device, and the power supply.

18. A method in accordance with claim 17, wherein configuring the electromachining module to provide instruction signals to the electromachining tool comprises configuring the electromachining module to provide at least one of a coolant conductivity instruction and a coolant temperature instruction to the electromachining tool.

19. A method in accordance with claim 17, wherein configuring the electromachining module to provide instruction signals to the power supply comprises configuring the electromachining module to provide at least one of a power supply on/off instruction, a power supply enable/disable instruction, a power supply peak voltage setting instruction, a power supply peak current setting instruction, and a power supply pulse on/off time instruction to the power supply.

20. A method in accordance with claim 17, wherein configuring the electromachining module to provide instruction signals to the CNC device comprises configuring the electromachining module to provide at least one of a feedrate override instruction signal, a contact sensing instruction signal, and a jump up/down instruction signal to the CNC device.
